(19) United States
(12) Patent Application Publication
(10) Pub. No.: US 2008/0130526 A1
(43) Pub. Date: Jun. 5, 2008

(54) Apparatus, method and computer program product providing LCR-TDD compatible frame structure

(75) Inventor: Xiangguang Che, Beijing (CN)

Correspondence Address: HARRINGTON & SMITH, PC, 4 RESEARCH DRIVE, SHELTON, CT, 06484-6212, US

(73) Assignee: Nokia Corporation

(21) Appl. No.: 11/998,689

(22) Filed: Nov. 30, 2007

Related U.S. Application Data
(60) Provisional application No. 60/861,781, filed on Nov. 30, 2006.

(51) Int. Cl. H04J 3/00; H04Q 7/20

(52) U.S. Cl. 370/280; 370/345; 455/452.1

(57) ABSTRACT

Method, apparatus and computer program product are configured to operate an electronic device in a wireless communications system to communicate with other electronic devices operative in the wireless communications system; and to establish a radio frame, the radio frame further comprising a radio sub-frame to be used by other electronic devices operating in the wireless communications network, the radio sub-frame having a variable uplink time transmission interval and variable downlink time transmission interval, the variable transmission time intervals implemented with a variable switch point between uplink and downlink timeslots. Other method, apparatus and computer program product are configured to operate an electronic device in a wireless communications system to perform bidirectional communication operations in a wireless communications network; and to operate with a radio frame established by the wireless communications network, the radio frame further comprising a radio sub-frame, the radio sub-frame having a variable uplink transmission time interval and a variable downlink transmission time interval, the variable transmission time intervals implemented with a variable switch point between uplink and downlink timeslots.

### CROSS-REFERENCE TO A RELATED PROVISIONAL PATENT APPLICATION

This application hereby claims priority under 35 U.S.C. § 119(e) from co-pending provisional U.S. Patent Application No. 60/861,781 entitled “Apparatus, Method and Computer Program Product Providing LCR-TDD Compatible Frame Structure” filed on Nov. 30, 2006 by Xiangguang Che. The disclosure of provisional U.S. Patent Application Ser. No. 60/861,781 is hereby incorporated by reference in its entirety.

### TECHNICAL FIELD

The exemplary and non-limiting embodiments of this invention relate generally to wireless communication systems, methods, devices and computer program products and, more specifically, relate to techniques to provide time division duplex uplink and downlink waveforms.

### BACKGROUND

The following abbreviations that appear in the description and/or drawing figures are herewith defined:
3GPP third generation partnership project
ACK acknowledge
BW bandwidth
CDM code division multiplexing
CQI channel quality indicator
DUSP switching point from downlink to uplink
DwPTS downlink pilot timeslot physical channel
E-UTRAN evolved UTRAN
FDD frequency division duplex
FDMA frequency division multiple access
GP guard period
HARQ hybrid automatic repeat request
LCR low chip rate
LTE long term evolution
MAC medium access control
NACK not acknowledge, negative acknowledge
Node-B Base Station
eNB EUTRAN Node B
OFDM Orthogonal Frequency Domain Multiplex
PS packet scheduling
SC-FDMA single carrier, frequency division multiple access
TDD time division duplex
TTI transmission time interval
UDSP switching point from uplink to downlink
UE user equipment
UL uplink
UpPTS uplink pilot timeslot physical channel
UTRAN universal terrestrial radio access network

A proposed communication system known as evolved UTRAN (E-UTRAN, also referred to as UTRAN-LTE) is currently under discussion within the 3GPP. The current working assumption is that the DL access technique will be OFDMA, and the UL technique will be SC-FDMA. In the E-UTRAN system both the FDD and TDD modes will be considered equally important. Reference can be made to 3GPP TR 25.814, V7.0.0 (2006-06), 3rd Generation Partnership Project; Technical Specification Group Radio Access Network; Physical layer aspects for evolved Universal Terrestrial Radio Access (UTRA) (Release 7).

In 3GPP TS 25.814 two frame-structure options for LTE TDD are described. One of the two options is a LCR-TDD compatible frame structure (see Section 6.2.1.1.1 and FIG. 6.2.1.1-1) to accommodate coexistence with LCR-TDD. FIG. 6.2.1.1-1 of 3GPP TS 25.814 is shown herein as FIG. 2. In practice, the LCR-TDD compatible frame structure requires (strictly): 1) that the 5 ms frame length is unchanged; and 2) that the timeslot timing within the 5 ms radio frame is unchanged, including both the length of the data timeslots (TS0-TS6) and the position of the special timeslots (DwPTS, GP1, UpPTS).

As may be appreciated, since the 5 ms radio frame length and timeslot timing are unchanged there are but a few characteristics that can be used as working assumptions for the LTE TDD. For example, within a 5 ms radio frame the DL and UL share the timeslots according to the position of the switch point. Further, if there is only one switch point within one 5 ms radio frame, which is the case in the current LCR-TDD, then (a) the DL channel status is updated via the UL (either using a CQI report or by sounding) at most once per Sms, (b) grant signaling (to both the DL and UL) via DL control signaling is updated at most once per 5 ms, (c) the ACK/NACK is transmitted in both the DL and UL at most once per Sms and (d) the (conventional) transmission or retransmission occurs after receiving ACK/NACK at most once per 5 ms.

### SUMMARY OF THE INVENTION

A first embodiment of the invention is an electronic device comprising: radio apparatus configured to perform bidirectional communication operations in a wireless communications network; and a control apparatus configured to establish a radio frame, the radio frame further comprising a radio sub-frame configured to be used by other electronic devices operating in the wireless communications network, the radio sub-frame having a variable uplink transmission time interval and a variable downlink transmission time interval, the control apparatus further configured to implement the variable uplink transmission time interval and the variable downlink transmission time interval using a variable switch point between uplink and downlink timeslots.

A second embodiment of the invention is an electronic device comprising: radio apparatus configured to perform bidirectional communication operations in a wireless communication network; and a control apparatus configured to operate with a radio frame established by the wireless communications network, the radio frame further comprising a radio sub-frame, the radio sub-frame having a variable uplink transmission time interval and a variable downlink transmission time interval implemented by a variable switch point between uplink and downlink timeslots.

A third embodiment of the invention is a computer program product comprising a computer readable memory medium embodying a computer program, the computer program configured to operate an electronic device in a wireless communications network, wherein when the computer program is executed, the electronic device is configured to communicate with other electronic devices in the wireless communications network; and to establish a radio frame, the radio frame further comprising a radio sub-frame configured to be used by the other electronic devices operating in the wireless communications network, the radio sub-frame having a variable uplink transmission time interval and a variable downlink transmission time interval, the variable uplink transmission time interval and variable downlink transmission time interval implemented using a variable switch point between uplink and downlink timeslots.

A fourth embodiment of the invention is a computer program product comprising a computer readable memory medium embodying a computer program, the compute program configured to operate an electronic device in a wireless communications network, wherein when the computer program is executed the electronic device is configured to communicate with other electronic devices in the wireless communications network; and to operate with a radio frame established by the wireless communications network, the radio frame further comprising a radio sub-frame, the radio sub-frame having a variable uplink transmission time interval and a variable downlink transmission time interval, the variable uplink transmission time interval and variable downlink transmission time interval implemented using a variable switch point between uplink and downlink timeslots.

A fifth embodiment of the invention is a method comprising: performing bidirectional communication operations in a wireless communications network; and establishing a radio frame, the radio frame further comprising a radio sub-frame configured to be used by other electronic devices operating in the wireless communications network, the radio sub-frame having a variable uplink transmission time interval and a variable downlink time transmission interval, the variable uplink transmission time interval and variable downlink transmission time interval implemented using a variable switch point between uplink and downlink timeslots.

A sixth embodiment of the invention is a control apparatus configured for incorporation in an electronic device operative in a wireless communications network, the control apparatus comprising circuitry configured to operate with a radio frame established by the wireless communications network, the radio frame further comprising a radio sub-frame, the radio sub-frame having a variable uplink transmission time interval and a variable downlink transmission time interval, the variable uplink transmission time interval and variable downlink transmission time interval implemented using a variable switch point between uplink and downlink timeslots, wherein the control apparatus is further configured to respond to a change in a position of the switch point by operating with a new transmission time interval configuration in the uplink and downlink timeslots of the sub-frame.

### BRIEF DESCRIPTION OF THE DRAWINGS

In the attached Drawing Figures:

FIG. 1 shows a simplified block diagram of various electronic devices that are suitable for use in practicing the exemplary embodiments of this invention;

FIG. 2 reproduces FIG. 6.2.1.1-1 of 3GPP TS 25.814, and shows a frame structure of one pair of switching points between DL and UL traffic slots;

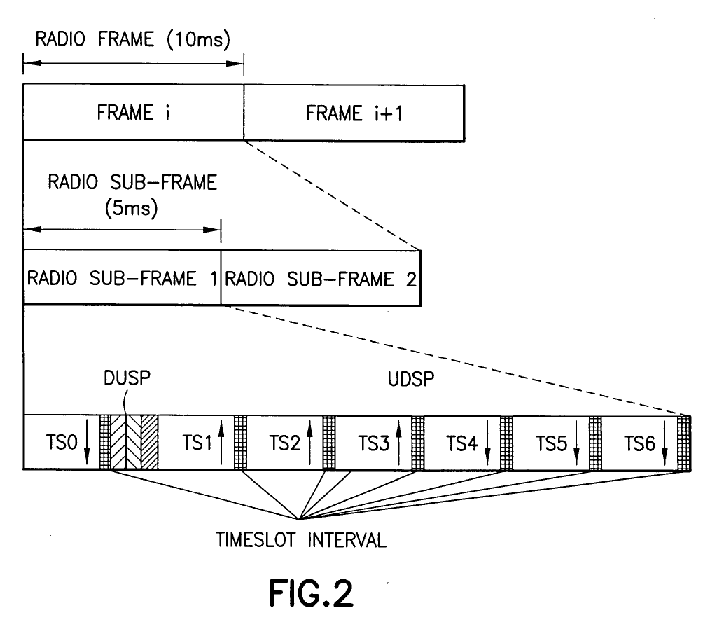

FIG. 3 is an example of ACK/NACK transmission;

FIG. 4 is a flowchart depicting a method operating in accordance with the invention; and

FIG. 5 is a flowchart depicting another method operating in accordance with the invention.

### DETAILED DESCRIPTION

In view of the subject matter discussed above in the Background section, it may be appreciated that a question arises as to what should be the length of the TTI.

In a first case, where the TTI length is one sub-frame, then the control signaling overhead will be large due at least to increased grant and ACK/NACK signaling. Further, the DL scheduling gain will be limited because the CQI is updated only once per 5 ms in the UL. Further, almost no UL scheduling gain will be present because no UL sounding update, and no UE buffer update, will be present during the 5 ms radio frame. In addition, time diversity is limited, and the transmission efficiency is reduced since the smaller the resource unit (Frequency×Time) the greater will be the segmentation probability (which leads to increased overhead, e.g. CRC, MAC_ID, ACK/NACK, etc.) In addition, the HARQ retransmission delay is reduced and constrained to be 5 ms if only one pair of switch point exists, unless some other approach is used, e.g., automatic retransmission without receiving ACK/NACK, which is actually more in the way of a repetition than a retransmission.

In a second case, where additional TTI length is defined, there may be at least two options available, where a TTI length of one sub-frame is one (preferably the first) of the options. In this case, if the second option is a TTI length of two sub-frames, there is no clear improvement as compared to the one sub-frame TTI length discussed above. However, if the second option is a TTI of three or more sub-frame lengths, then for some switch point position then either the DL or the UL, or both directions, cannot support the option. For example, if a two timeslot length TTI is used for the UL and a four timeslot length TTI is used for the DL, then the UL cannot support a TTI of length three sub-frames, and the UL must then use the one sub-frame length TTI (with the attendant drawbacks discussed above). Further, the DL must use the two sub-frame length TTI simultaneously, which increases complexity, or it must use only the TTI of only one sub-frame length.

As may be appreciated, the only obvious gain that is realized by having the TTI length equal one sub-frame (5 ms) is that more UEs can be scheduled in a 5 ms radio frame. However, the question arises as to whether the benefit that is realized by the increase in the number of scheduled UEs is offset by the various drawbacks that were discussed above.

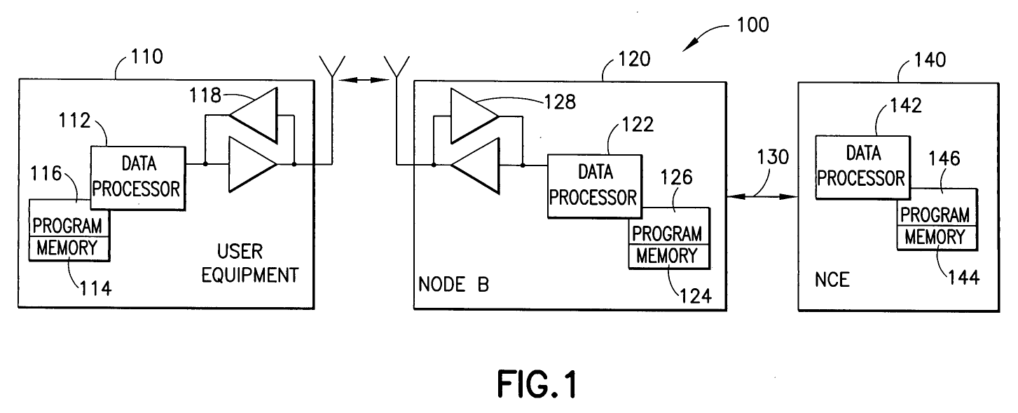

Before describing in detail the exemplary embodiments of this invention, a description is first made of FIG. 1 for illustrating a simplified block diagram of various electronic devices that are suitable for use in practicing the exemplary embodiments of this invention. In FIG. 1 a wireless network 100 is adapted for communication with a UE 110 via a Node B (base station) 120, also referred to herein as an eNB 120. The network 100 may include a network control element (NCE) 140. The UE 100 includes a data processor (DP) 112, a memory (MEM) 114 that stores a program (PROG) 116, and a suitable radio frequency (RF) transceiver 118 for bidirectional wireless communications with the Node B 120, which also includes a DP 122, a MEM 124 that stores a PROG 126, and a suitable RF transceiver 128. The Node B 120 is coupled via a data path 130 to the NCE 140 that also includes a DP 142 and a MEM 144 storing an associated PROG 146. At least one of the PROGs 116 and 126 is assumed to include program instructions that, when executed by the associated DP, enable the electronic device to operate in accordance with the exemplary embodiments of this invention, as will be discussed below in greater detail.

That is, the exemplary embodiments of this invention may be implemented at least in part by computer software executable by the DP 112 of the UE 110 and by the DP 122 of the Node B 120, or by hardware, or by a combination of software and hardware.

In general, the various embodiments of the UE 110 can include, but are not limited to, cellular telephones, personal digital assistants (PDAs) having wireless communication capabilities, portable computers having wireless communication capabilities, image capture devices such as digital cameras having wireless communication capabilities, gaming devices having wireless communication capabilities, music storage and playback appliances having wireless communication capabilities, Internet appliances permitting wireless Internet access and browsing, as well as portable units or terminals that incorporate combinations of such functions.

The MEMs 114, 124 and 144 may be of any type suitable to the local technical environment and may be implemented using any suitable data storage technology, such as semiconductor-based memory devices, magnetic memory devices and systems, optical memory devices and systems, fixed memory and removable memory. The DPs 112, 122 and 142 may be of any type suitable to the local technical environment, and may include one or more of general purpose computers, special purpose computers, microprocessors, digital signal processors (DSPs) and processors based on a multi-core processor architecture, as non-limiting examples.

Describing now the various non-limiting and exemplary embodiments of this invention, in order to generalize the exemplary embodiments of this invention to be applicable for any TDD system, define a radio frame as a basic and minimum repeating periodic pattern in which DL, UL and other timeslots share the available resources.

In this case assume that there is only one TTI length for the DL and one TTI length for the UL within every radio frame (such as within a 5 ms (or other duration) radio frame), regardless of where the switch point is located (i.e., regardless of how many sub-frames area allocated for the DL and UL transmissions). Further, the DL TTI length (duration) may be different than the UL TTI length (duration), depending on the position of the switch point within the radio frame.

In a first example, assume that TS1-TS3 are allocated for the UL and that TS4-TS6 are allocated for the DL. In this example then the UL TTI length is three sub-frames and the DL TTI length is also three sub-frames. In a second example, assume that TS1-TS2 are allocated for the UL and that TS3-TS6 are allocated for the DL. In this example then the UL TTI length is two sub-frames and the DL TTI length is four sub-frames. In a third example, assume that TS1-TS4 are allocated for the LL and that TS5-TS6 are allocated for the DL. In this example then the UL TTI length is four sub-frames and the DL TTI length is two sub-frames. In a fourth example, assume that TS1 is allocated for the UL and that TS2-TS6 are allocated for the DL. In this example then the UL TTI length is one sub-frame and the DL TTI length is five sub-frames.

One may also assume that the TTI length is fixed so long as the switch point does not change, and that within a TTI the users (UEs 110) are multiplexed by means of FDM for both the UL and DL.

It should be noted that whether multiple UEs 110 are time division multiplexed in one TTI is not germane to an understanding the invention, and is not further considered.

It should also be noted that based on the foregoing description of the exemplary embodiments of this invention that the HARQ retransmission delay may increase. However, the HARQ retransmission delay directly depends on the delay of the ACK/NACK of L1 (physical layer) data packets in the opposite direction. As was noted above, the lower bound for the HARQ retransmission delay is 5 ms if only one pair of switch points exist. As such, the preferred approach preferably is targeted to also have the same lower bound for the HARQ retransmission delay, that is, to feedback within 5 ms the ACK/NACK in the opposite direction of the data packets.

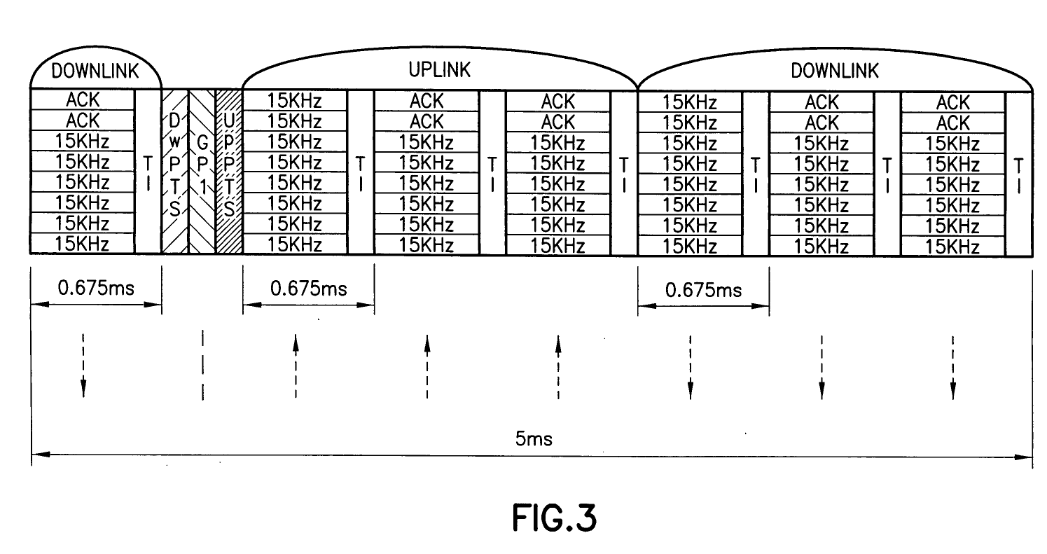

Referring to FIG. 3 it is shown that this is feasible if the turbo decoder of the receiver has a maximum decoding processing time of about 0.4 ms. This is a valid assumption, since one can expect that E-UTRA will employ Turbo coding, that the Turbo decoder will need 16 samples per bit per 8 iterations, that the maximum Turbo code size is 5114 bits, that the processor is a 200 MHz processor (as a non-limiting example). Taking all of the foregoing assumptions under consideration, the total decoding time is: (16*5114)/200*10⁶, or about 0.4 ms.

Still referring to FIG. 3, the feasibility of achieving the lower bound for the HARQ retransmission delay of 5 ms is further assumed by sending the ACK/NACK as a data-non-associated signal that need not be coded together with the UL/DL data, and by making the sub-frame length to be 0.675 ms, and the special timeslot length (all together) to be 0.275 ms. Further, it can be arranged for the UE 110 or the eNB 120 to begin to transmit the ACK/NACK from the second (or later) UL or DL sub-frame, depending on ACK/NACK performance requirements and any “pre-agreement” between the UE 110 and the eNB 120, as the frequency and time position of the ACK/NACK should be known a priori to the UE 110 and the eNB 120.

It should be noted that the details of the ACK/NACK mapping (in terms of position and pattern in frequency and time) can vary widely, and is not germane to an understanding the of the exemplary embodiments of this invention.

Based on the foregoing, it can be appreciated that it is feasible to feedback the ACK/NACK to the transmitter within Sms, and thus the overall round trip time across the air interface is not degraded by the use of the exemplary embodiments of this invention.

A number of advantages can be gained by the use of the exemplary embodiments of this invention, including a reduction in control signaling overhead, a reduction in grant signaling for both the UL and DL, a reduction in ACK/NACK overhead and, further, there is no scheduling gain loss. In addition, the time diversity gain is improved, and the transmission efficiency is increased due at least to a reduction in L2 segmentation. Further, the use of the exemplary embodiments of this invention provides a simple configuration, since the UE 110 implicitly knows the TTI configuration by knowing the location of the UL/DL switch point.

In addition, the PS (frequency division PS) for both the UL and the DL can be performed and signaled once per 5 ms, e.g. at the beginning of the DL sub-frame, although the details of this signaling are not germane to an understanding of the exemplary embodiments of this invention. Further, the DL control signaling overhead is reduced because of less frequent scheduling signaling transmissions and fewer scheduled users L1 PDU per 5 ms radio frame scheduling. The ACK/NAK overhead is reduced because there are fewer scheduled users L1 PDU per 5 ms radio sub-frame. The performance gain can be due to the larger coding block, the reduced segmentation overhead, and possibly the reduced Guard Period. A power saving is also made possible, since the UE 110 checks the control channel only once per 5 ms, and then may go to the DRX/DTX (discontinuous reception/transmission) mode if not scheduled. Further, there is no performance loss from the FDPS as the CQI feedback is updated only every 5 ms.

It can also be noted that the threshold of number of active (scheduled) users per UL or DL per 5 ms sub-frame may be decreased based on the number of RB/RU (resource blocks/resource units), regardless of the location of the switch point. For example per 5 ms frame, there may be 6 users/1.25 MHz, 25 users/5 MHz and so forth.

Based on the foregoing it should be apparent that the exemplary embodiments of this invention provide a method, apparatus and computer program product(s) to provide a radio sub-frame having a switch point between UL and DL time slots (UDSP) that is variable for providing a variable UL TTI and DL TTI with no signaling required between the UE and the eNB.

The method, apparatus and computer program product(s) as in the previous paragraph, where a radio sub-frame comprises an initial DL time slot, a plurality of timeslots providing pilot channels and a guard period, and N UL timeslots and M DL timeslots, where during a particular radio sub-frame N may be equal to, less than, or greater than M.

Further in accordance with the exemplary embodiments of this invention there is provided a network node, such as a Node B or an eNB, where a radio sub-frame is established so as to comprise an initial DL time slot, a plurality of timeslots providing pilot channels and a guard period, and N UL timeslots and M DL timeslots, where during a particular radio sub-frame N may be equal to, less than, or greater than M.

Further in accordance with the exemplary embodiments of this invention there is provided a user equipment, such as a cellular phone, that is adapted to operate with a radio sub-frame that comprises an initial DL time slot, a plurality of timeslots providing pilot channels and a guard period, and N UL timeslots and M DL timeslots, where during a particular radio sub-frame N may be equal to, less than, or greater than M.

Further in accordance with the exemplary embodiments of this invention there is provided an integrated circuit device or module that is adapted to be installed in a node of a wireless communication system, where the integrated circuit device or module is adapted to operate with a radio sub-frame that comprises an initial DL time slot, a plurality of timeslots providing pilot channels and a guard period, and N UL timeslots and M DL timeslots, where during a particular radio sub-frame N may be equal to, less than, or greater than M.

The integrated circuit device or module as in the previous paragraph, where the node is comprised of a base station and/or a user equipment.

The exemplary embodiments of this invention can be realized from the operation of computer program code, and/or as a plurality of coupled logic circuit elements constructed to carry out the associated function(s).

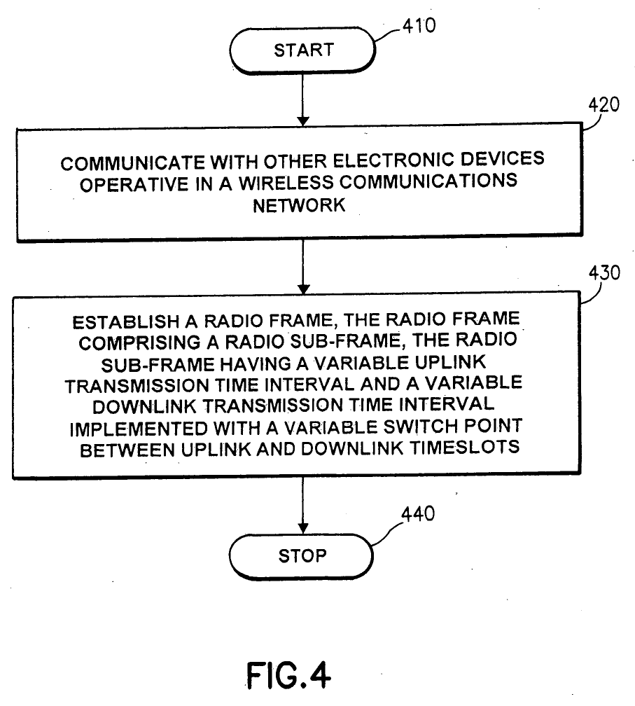

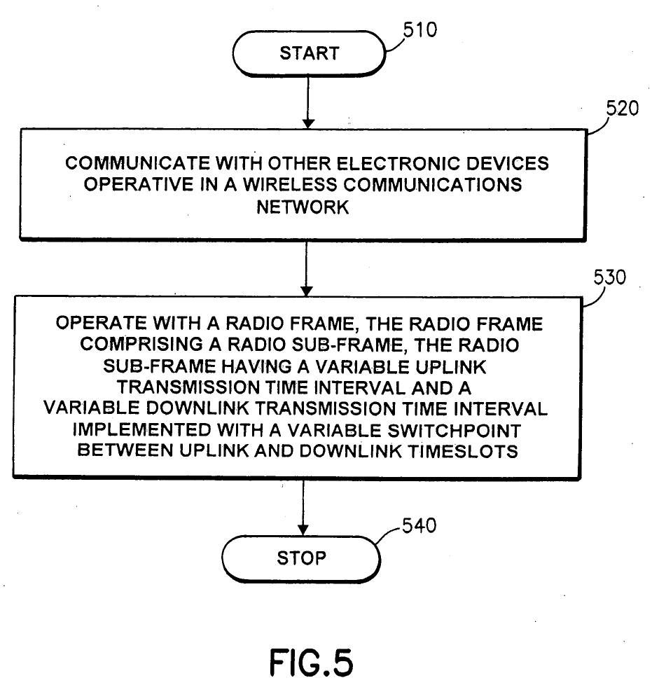

The methods of the present invention are summarized in FIGS. 4 and 5. FIG. 4 is a flowchart depicting a method operative in a base station. The method starts at 410. Next, the base station communicates with other electronic devices (such as, for example, user equipment) operative in the wireless communications system. Then, at 430, the base station establishes a radio frame comprising a radio sub-frame. The radio sub-frame has a variable uplink transmission time interval and a variable downlink transmission time interval. The variable transmission time intervals are implemented with a variable switch point between uplink and downlink time slots. The method stops at 440.

FIG. 5 is a flowchart depicting a method implemented in user equipment operative in a wireless communication system. The method starts at 510. Next, at 520, the user equipment communicates with other electronic devices operative in a wireless communications network. Then, at 530, the user equipment operates with a radio frame, the radio frame further comprising a radio sub-frame. The radio sub-frame has a variable uplink transmission time interval and a variable downlink transmission time interval. The variable transmission time intervals are implemented with a variable switch point between uplink and downlink time slots. The method stops at 540.

In general, the various exemplary embodiments may be implemented in hardware or special purpose circuits, software, logic or any combination thereof. For example, some aspects may be implemented in hardware, while other aspects may be implemented in firmware or software which may be executed by a controller, microprocessor or other computing device, although the invention is not limited thereto. While various aspects of the exemplary embodiments of this invention may be illustrated and described as block diagrams or by using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

As such, it should be appreciated that at least some aspects of the exemplary embodiments of the inventions may be practiced in various components such as integrated circuit chips and modules. The design of integrated circuits is by and large a highly automated process. Complex and powerful software tools are available for converting a logic level design into a semiconductor circuit design ready to be fabricated on a semiconductor substrate. Such software tools can automatically route conductors and locate components on a semiconductor substrate using well established rules of design, as well as libraries of pre-stored design modules. Once the design for a semiconductor circuit has been completed, the resultant design, in a standardized electronic format (e.g., Opus, GDSII, or the like) may be transmitted to a semiconductor fabrication facility for fabrication as one or more integrated circuit devices.

Various modifications and adaptations to the foregoing exemplary embodiments of this invention may become apparent to those skilled in the relevant arts in view of the foregoing description, when read in conjunction with the accompanying drawings. However, any and all modifications will still fall within the scope of the non-limiting and exemplary embodiments of this invention.

For example, while the exemplary embodiments have been described above in the context of the E-UTRAN (UTRAN-LTE) system, it should be appreciated that the exemplary embodiments of this invention are not limited for use with only this one particular type of wireless communication system, and that they may be used to advantage in other wireless communication systems.

Furthermore, some of the features of the various non-limiting and exemplary embodiments of this invention may be used to advantage without the corresponding use of other features. As such, the foregoing description should be considered as merely illustrative of the principles, teachings and exemplary embodiments of this invention, and not in limitation thereof.

What is claimed is:

1. An electronic device comprising:
radio apparatus configured to perform bidirectional communication operations in a wireless communications network; and
a control apparatus configured to establish a radio frame, the radio frame further comprising a radio sub-frame configured to be used by other electronic devices operating in the wireless communications network, the radio sub-frame having a variable uplink transmission time interval and a variable downlink transmission time interval, the control apparatus further configured to implement the variable uplink transmission time interval and the variable downlink transmission time interval using a variable switch point between uplink and downlink timeslots.

2. The electronic device of claim 1 wherein the wireless communications network is an E-UTRAN network.

3. The electronic device of claim 1 wherein the wireless communications network implements a time-division duplex multiplexing system.

4. The electronic device of claim 1 where the radio sub-frame further comprises an initial DL time slot, a plurality of timeslots providing pilot channels and a guard period, and N uplink time slots and M downlink timeslots.

5. The electronic device of claim 4 where during a particular radio sub-frame N is equal to M.

6. The electronic device of claim 4 where during a particular radio sub-frame N is less than M.

7. The electronic device of claim 4 where during a particular radio sub-frame N is greater than M.

8. An electronic device comprising:
radio apparatus configured to perform bidirectional communication operations in a wireless communication network; and
a control apparatus configured to operate with a radio frame established by the wireless communications network, the radio frame further comprising a radio sub-frame, the radio sub-frame having a variable uplink transmission time interval and a variable downlink transmission time interval implemented by a variable switch point between uplink and downlink timeslots.

9. The electronic device of claim 8 wherein the wireless communications network is an E-UTRAN network.

10. The electronic device of claim 8 wherein the wireless communications network implements a time division duplex multiplexing system.

11. The electronic device of claim 8 where the radio sub-frame further comprises an initial downlink time slot, a plurality of timeslots providing pilot channels and a guard period, and N uplink time slots and M down link time slots.

12. The electronic device of claim 11 where during a particular radio sub-frame N is equal to M.

13. The electronic device of claim 11 where during a particular radio sub-frame N is less than M.

14. The electronic device of claim 11 where during a particular radio sub-frame N is greater than M.

15. The electronic device of claim 8 wherein the control apparatus is further configured to determine a transmission time configuration implemented in downlink and uplink timeslots from a position of the switching point in the sub-frame.

16. The electronic device of claim 8 wherein the control apparatus is further configured to respond to a change in the switch point by varying a time transmission interval configuration in the uplink and downlink timeslots.

17. A computer program product comprising a computer readable memory medium embodying a computer program, the computer program configured to operate an electronic device in a wireless communications network, wherein when the computer program is executed, the electronic device is configured to communicate with other electronic devices in the wireless communications network; and to establish a radio frame, the radio frame further comprising a radio sub-frame configured to be used by the other electronic devices operating in the wireless communications network, the radio sub-frame having a variable uplink transmission time interval and a variable downlink transmission time interval, the variable uplink transmission time interval and variable downlink transmission time interval implemented using a variable switch point between uplink and downlink timeslots.

18. A computer program product comprising a computer readable memory medium embodying a computer program, the compute program configured to operate an electronic device in a wireless communications network, wherein when the computer program is executed the electronic device is configured to communicate with other electronic devices in the wireless communications network; and to operate with a radio frame established by the wireless communications network, the radio frame further comprising a radio sub-frame, the radio sub-frame having a variable uplink transmission time interval and a variable downlink transmission time interval, the variable uplink transmission time interval and variable downlink transmission time interval implemented using a variable switch point between uplink and downlink timeslots.

19. A method comprising:
performing bidirectional communication operations in a wireless communications network; and
establishing a radio frame, the radio frame further comprising a radio sub-frame configured to be used by other electronic devices operating in the wireless communications network, the radio sub-frame having a variable uplink transmission time interval and a variable downlink time transmission interval, the variable uplink transmission time interval and variable downlink transmission time interval implemented using a variable switch point between uplink and downlink timeslots.

20. Control apparatus configured for incorporation in an electronic device operative in a wireless communications network, the control apparatus comprising circuitry configured to operate with a radio frame established by the wireless communications network, the radio frame further comprising a radio sub-frame, the radio sub-frame having a variable uplink transmission time interval and a variable downlink transmission time interval, the variable uplink transmission time interval and variable downlink transmission time interval implemented using a variable switch point between uplink and downlink timeslots, wherein the control apparatus further is configured to respond to a change in a position of the switch point by operating with a new transmission time interval configuration in the uplink and downlink timeslots of the sub-frame.
